(19) United States
(12) Patent Application Publication
(10) Pub. No.: US 2014/0042783 A1
(43) Pub. Date: Feb. 13, 2014

(54) Rotatable platform having a straddleable seat to facilitate tranfer to a person having limited mobility

(71) Applicants: Richard A. St.Pierre, Horseheads, NY (US); Fletcher W. Chapin, Vestal, NY (US); David W. Dranchak, Endwell, NY (US)

(72) Inventors: Richard A. St.Pierre, Horseheads, NY (US); Fletcher W. Chapin, Vestal, NY (US); David W. Dranchak, Endwell, NY (US)

(21) Appl. No.: 13/998,179

(22) Filed: Oct. 9, 2013

Related U.S. Application Data
(63) Continuation-in-part of application No. 12/904,398, filed on Oct. 14, 2010, now abandoned.

(51) Int. Cl. A61G 5/10

(52) U.S. Cl. CPC A61G 5/10
USPC 297/195.11

(57) ABSTRACT

A transitioning device incorporating a rotatable platform supported on a base and having an elongated straddleable seat supported above the rotatable platform. A mechanism, either manual or powered, is provided to selectively rotate the rotatable base to facilitate moving a user to allow the user to transition from a first location to a second location angularly displaced from the first location. A user may desirably mount the seat when moving in a forward direction. Suitable hand rails and other support structures are provided to assist a user in mount and dismounting the seat. The seat may optionally be removable. Wheels or casters may be provided to facilitate moving the transitioning device. In one embodiment, a propulsion system may be included in the device. The fundamental functional concepts of the transitioning device may be combined with other devices to impart similar mobility benefits thereto.

### RELATED PATENT APPLICATIONS

This application is a Continuation-in-Part of U.S. patent application Ser. No. 12/904,398, filed Oct. 14, 2010, that is hereby incorporated herein in its entirety by reference.

### FIELD OF THE INVENTION

The present invention relates to devices intended to assist people with physical handicaps or limited mobility to transition between a first position and a second position, and more particularly to a rotatable platform having a straddleable seat that allows a user of the rotatable platform to safely and more easily mount the straddleable seat, rotate to a different position, and exit.

### BACKGROUND OF THE INVENTION

There have been many devices developed over the years to assist people with physical handicaps or limited mobility. Such devices range from simple, self-powered devices requiring the user to stand; to powered, steerable devices with at least three wheels, typically accommodating seated users.

A limitation of many of such existing devices is that it is difficult for a user to get on the device. Often getting on the device requires the person either to stand up and/or to be able to move onto a seat. Seats associated with devices of the prior art typically include a back and oftentimes arms. As used herein the term “seat” is defined as the component of a chair or other such structure upon which a user sits. A seat, therefore, as used herein is intended to support the buttocks of a user. While a back and arms on a seat may be beneficial to a person's comfort and safety once that person is positioned on the seat, their presence may make it more difficult for that person to get onto (i.e., mount) the seat. This potential interference to a user caused by the inclusion of a back or arms may depend on from which direction the person is approaching the straddleable seat of the rotatable platform.

One factor that can make it easier for a person to get onto a seat is if the seat is rotatable. Even when a seat may be rotated, a user may still be required to move backward in order to sit on the seat. It is both difficult and unsettling for a person to have to back onto (i.e., move backward onto) a device, especially if there are no auxiliary means, such as handles, rails or bars to grab or hold onto to provide at least a feeling of safety.

Anecdotal evidence is available from users of currently available devices as well as from potential users of improved devices that indicate that it would be desirable to provide a device that was easy and safe to mount and dismount from a forward direction. It appears that such a device would find acceptance in the marketplace.

### SUMMARY OF THE INVENTION

The present invention provides a family of transitioning devices each having a rotatable platform supported on a base. An elongated seat without attached arms or a back is supported on the rotary platform. Auxiliary supports may be temporarily installed on the platform once a user is in place on the seat.

A user moving in a forward direction approaches the seat, straddles the elongated seat, and then sits down upon the elongated seat. The platform may then be rotated to a desired stopping point whereat the user simply moves off the elongated seat.

The transitioning device having a rotary platform and an elongated seat may be provided in stationery or mobile configurations. Either an AC or DC electric motor, in conjunction with a suitable controller, may be provided to selectively rotate the rotary platform.

It is therefore an object of the invention to provide a transitioning device having a rotatable platform supporting a straddleable seat.

It is another object of the invention to provide a transitioning device having a rotatable platform supporting a straddleable seat that allows a user to approach and mount the straddleable seat by moving in a forward direction onto the straddleable seat.

It is a further object of the invention to provide a transitioning device having a rotatable platform supporting a straddleable seat wherein auxiliary support structures may selectively be placed adjacent the straddleable seat.

It is yet another object of the invention to provide a transitioning device having a rotatable platform supporting a straddleable seat wherein a user moving in a forward direction may mount the device and, after rotation, dismount the straddleable seat.

It is still further object of the invention to provide a transitioning device having a rotatable platform supporting a straddleable seat that may be collapsed for transport or storage.

It is an additional object of the invention to provide a transitioning device having a rotatable platform supporting a straddleable seat that includes an electric motor and a controller for turning the rotatable platform.

It is another object of the invention to provide a transitioning device having a rotatable platform supporting a straddleable seat wherein the rotatable platform is supported above a base that includes castors or wheels to facilitate moving the transitioning device from one location to another.

### BRIEF DESCRIPTION OF THE DRAWINGS

A complete understanding of the present invention may be obtained by reference to the accompanying drawings, when taken in conjunction with the detailed description thereof and in which:

FIG. 1 is a perspective, schematic view of a transitioning device having a rotatable platform supporting a straddleable seat in accordance with the present invention;

FIG. 2 is a bottom plan, schematic view of the transitioning device of FIG. 1;

FIG. 3 is a side elevational, schematic view of the transitioning device of FIG. 1 with a user in a standing position disposed thereupon;

FIG. 4 is a side elevational, schematic view of the device shown in FIG. 1 with an individual in a seated position;

FIG. 5 is a perspective, schematic view of a second embodiment of transitioning device having a manually rotated platform supporting a straddleable seat in accordance with the present invention;

FIG. 6 is a perspective, schematic view of a third embodiment of a collapsible transitioning device in a non-collapsed, operational configuration;

FIG. 7 is a perspective, schematic view of the transitioning device of FIG. 6 in a collapsed configuration; and

FIG. 8 is a perspective, schematic view of a fourth embodiment of a transitioning device having a straddleable seat and a self-contained propulsion system.

### DETAILED DESCRIPTION OF THE PREFERRED EMBODIMENT

Generally speaking, the present invention provides a family of transitioning devices, each having a rotatable platform supporting an elongated, straddleable seat. These novel transitioning devices may be used to assist a person with limited mobility and/or physical ailments to safely and more easily enter onto the transitioning device from a first position (e.g., standing, sitting, moving from a bed, etc.), to stand or preferably sit on the sturdy, elongated straddleable seat, and to rotate to a desired angular orientation relative to the user's point of entry. Once rotated to a desired exit position, the user may dismount the straddleable seat at a second position (e.g., a wheel chair, a toilet seat, etc.). Because the user's motion is generally in a forward direction and auxiliary support structures are readily available to allow individuals the opportunity to be more self-reliant.

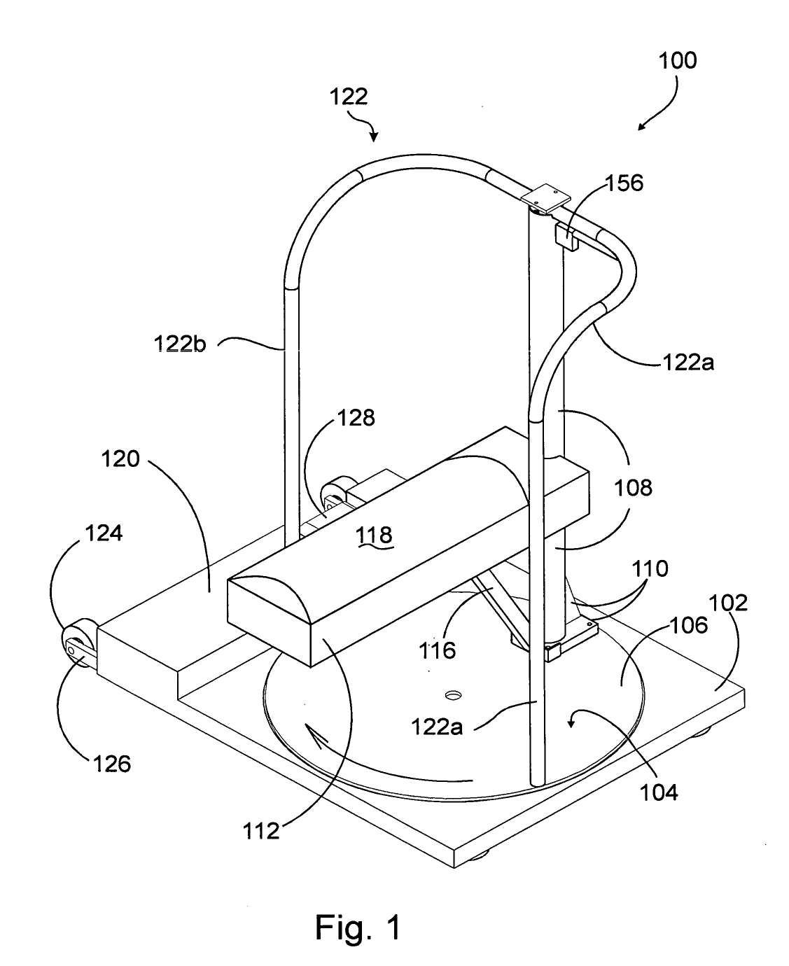

Referring first to FIG. 1, there is shown perspective, schematic view of a first embodiment of a transitioning device having a rotatable platform supporting an elongated, straddleable seat, generally at reference number 100.

Transitioning device 100 has a raised, hollow, generally rectangular support base 102 having an upper surface 104. While a generally rectangular support base or platform 102 has been chosen for purposes of disclosure, it will be recognized that other shapes may be substituted therefor. Consequently, the invention is not considered limited to the generally rectangular support base 102 chosen for purposes of disclosure.

A raised portion 120 is disposed along a side of raised, hollow, generally rectangular support base 102. The space within raised portion 120 may contain such elements as an electrical drive system for rotatable platform 106, a battery, a battery charger, a motor controller or other such components. These components are discussed in detail hereinbelow.

A removable battery pack 128 may be housed within raised portion 120 and typically, battery pack 128 may be removed from outside raised portion 120. It will be recognized that transitioning device 100 may be manually powered or powered by an AC motor, not shown, utilizing power from an external source of AC power. In these cases, removable battery pack 128 may not be required.

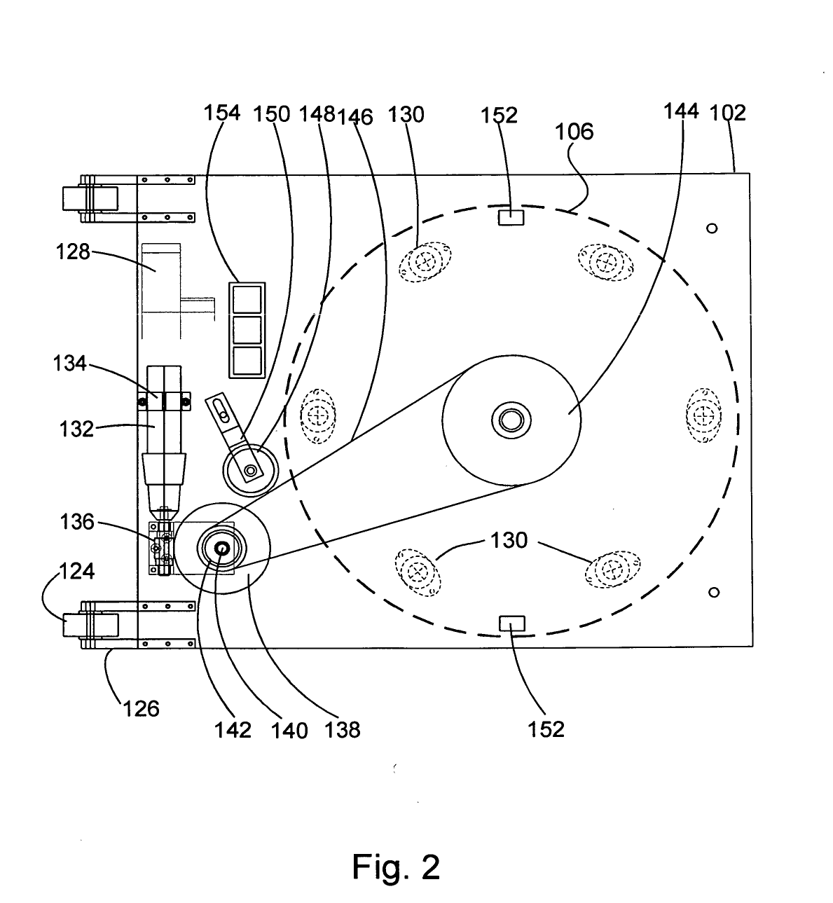

Rotatable platform 106 is disposed on upper surface 104 of support base 102. A bearing device 130, best seen in FIG. 2, is disposed between a lower surface, not specifically identified, of rotatable platform 106 and upper surface 104 of support base 102. One type of bearing device 130 found suitable is a circular ball or roller bearing chase. Such bearing devices are believed to be well known to those of skill in the art and, consequently are not further described or discussed herein. Such bearing devices are typically used in well known so-called “lazy Susan” devices. In other embodiments, multiple individual bearing devices 130 may be disposed under rotatable platform 106.

A vertical support column 108 having a vertical support column base 110 is attached to either upper surface 104 of rotatable platform 106 or to an upper surface of support base 102. Vertical support column 108 may be either fixedly or removably attached.

A tubular safety handrail 122 has two components 122a, 122b, each having a respective proximal end and a distal end. The distal end of each of components 122a, 122b is affixed to rotatable platform 106. The proximal ends of each of components meet at a top of vertical support column 108 and are each affixed thereto.

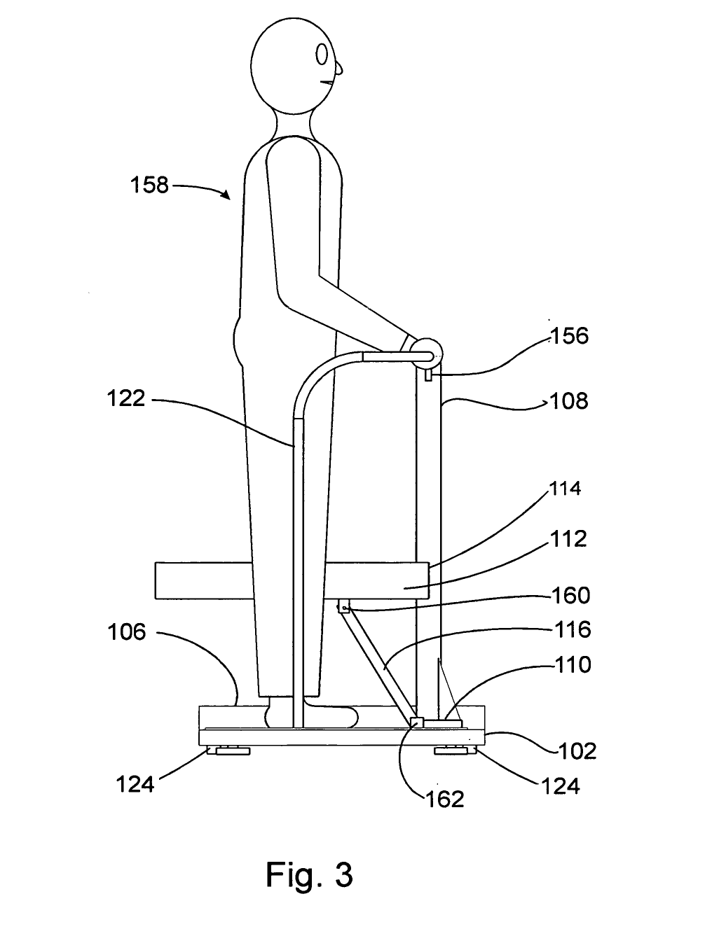

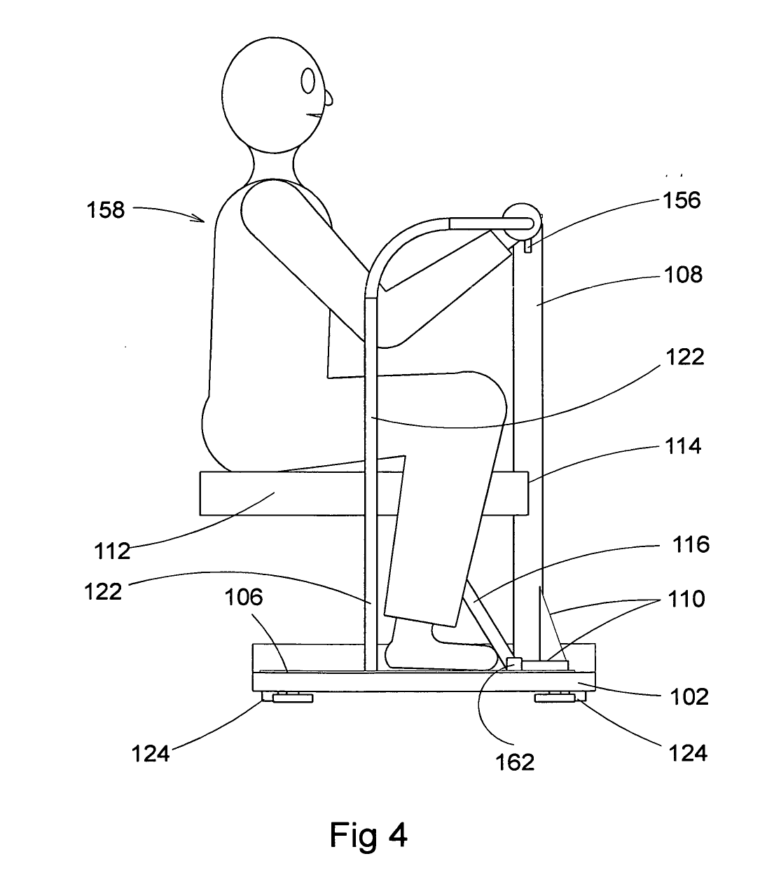

A user control switch 156 is disposed on tubular safety handrail 122, typically close to the junction tubular safety handrail components 122a, 122b and vertical support column 108. User control switch 156 is typically a lever switch that may control the rotation of rotatable platform 106. If desired, user control switch 156 may be implemented such that a user 158, best seen in FIGS. 3 and 4, may be required to maintain pressure on the switch lever to continue rotation of rotatable platform 106. Limit switches 152, best seen in FIG. 2 and discussed in more detail hereinbelow, may interrupt the rotation of rotatable platform 106.

An elongated, straddleable seat 112 is supported by a diagonal brace 116 affixed to a lower surface, not specifically identified, of seat 112 and to vertical support column base 110. Seat 112, has a semi-circular relief or cutout in a rear side edge thereof sized and configured to accept and slidingly engage an outer surface of vertical support column 108. Straddleable seat 112 and diagonal brace 116 are designed and configured to be removable from rotatable platform 106 and vertical support column 108.

Elongated, straddleable seat 112 may have an optional pad 118 on its upper surface. Pad 118 may be a removable pad or a pad permanently affixed to the upper surface of elongated, straddleable seat 112. Pad 118 may cover all of elongated, straddleable seal 112 or only a portion thereof.

Wheels 124 are affixed proximate a lower side edge of support base 102 by wheel brackets 126. Wheels 124 are useful for rolling transitioning device 100 from one location to another when required. It will be recognized that wheels 124 are optional and not required on transitioning devices 100 that need not be moved.

Referring now also to FIG. 2, there is shown a bottom plan, schematic view the transitioning device 100.

A drive motor 132 is secured to raised portion 120 by a drive motor bracket 134. A mechanical output of drive motor 132 is coupled to a worm gear assembly 136. Worm gear assembly 136 drives the outer edge of a worm gear sprocket 138. Worm gear sprocket 138 is mounted on a chain drive support shaft 140 via a bearing, not specifically identified.

A first chain sprocket 142 is fixedly attached to worm gear sprocket 138 and rotates synchronously therewith.

A second chain sprocket 144 is fixedly attached to rotatable platform 106. A drive chain 146 engages both first chain sprocket 142 and second chain sprocket 144.

A chain tensioning idler 148 supported on a support bracket 150 is disposed and configured to ride on an outer surface of drive chain 146. Chain tensioning idler 148 incorporates a spring mechanism, not specifically identified, that serves to bias chain tensioning idler 148 with a predetermined pressure.

A pair of limit switches 152 is disposed proximate rotatable platform 106 at typically approximately 180° apart. Limit switches 152 typically automatically turn power off through a limit switch relay 154 thereby stopping rotation of rotatable platform 106 at 180° or other preselected angular positions to allow user 158 (see FIGS. 3 and 4) to enter or exit transitional device 100.

It will be recognized that limit switches 152 may be disposed in a different angular relationship to one another. It will be further recognized that additional limit switches 152 may be added to meet a particular operating circumstance or environment. Consequently, the invention is not considered limited to two limit switches 152 disposed 180° apart shown for purposes of disclosure. Rather that invention is intended to include any number of limit switches disposed in an angular relationship(s) to one another.

Limit switches 152 are operatively connected to limit switch relay 154. In turn, limit switch relay 154 is operatively connected to drive motor 132. Limit switches 152, in combination with user control switch 156, best seen in FIG. 1, control drive motor 132. It will be recognized that additional components and/or connections, none shown, may be required to implement a complete control system for drive motor 132. Such components and arrangements are believed to be well know to those of skill in the art and, consequently, and are not further described or discussed herein.

Transitioning device 100 assists persons with physical handicaps or limitations but who have some arm strength to transition from a primary, fixed location (e.g., a bed) to a second location (e.g., a wheel chair, a toilet seat, etc.) safely and more easily. Transitioning device 100 typically accomplishes such transitions by rotating the user 158, for example from a bed to a wheel chair having a seat disposed at right angles to the bed. The enhanced sense of security provided to the user thereof allows individuals to be more self-reliant.

Transitioning device 100 can be tipped onto wheels 124 using safety handrail 122 as a handlebar to facilitate transporting transitioning device 100 to other locations.

Referring now also to FIGS. 3 and 4, there are shown side elevational, schematic views of the transitioning device of FIG. 1 with a user 158 disposed thereupon in a standing position and seated position, respectively.

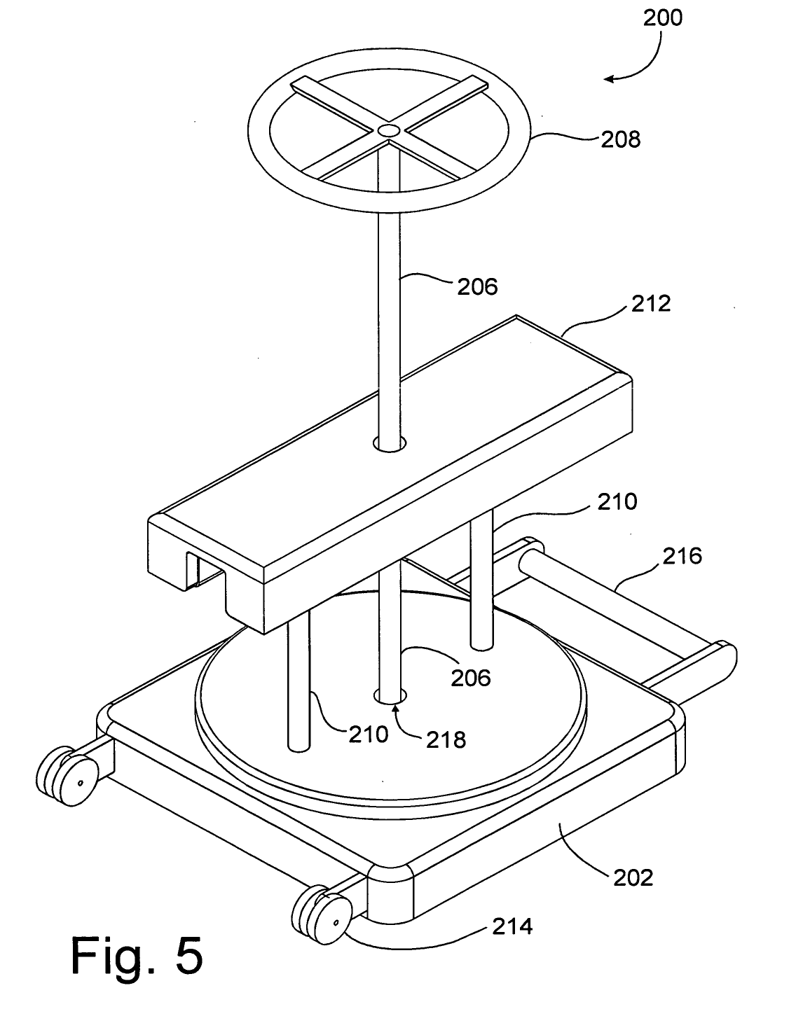

Referring now also to FIG. 5 there is shown perspective, schematic view of a second embodiment of a transitioning device having a manually rotated platform supporting a straddleable seat, generally at reference number 200.

Transitioning device 200 has a hollow, substantially rectangular support base 202 that supports a rotatable platform 204 on roller or ball bearings, not shown, allowing the rotation of rotatable platform 204 relative to support base 202 thereby allowing transferring a user in a circular rotation.

A vertical support column 206 having a handgrip 208 disposed at an upper end thereof. A lower end of vertical support column 206 is fixedly attached to support base 202.

Rotatable platform has a center opening 218 that allows rotatable platform 204 to encircle vertical support column 206 and rotate therearound.

An elongated straddleable seat 212 is fixedly supported on rotatable platform 204 by a pair of seat supports 210 attached to rotatable platform 204.

Optionally, wheels 214 and a handle assembly 216 affixed to support base 202 may be provided to facilitate moving transitioning device 200 for one location to another.

Unlike transitioning device 100, transitioning device 200 is manually powered by the user, typically while the user is seated on straddleable seat 212 and holding onto handgrip 208. Alternately, while the user is seated on straddleable seat 212, a caregiver or other individual, neither shown, may rotate rotatable platform 204. Typically, the user then grips either the vertical support column 206 or handgrip 208 for support.

Once the user has moved from a first location (e.g., a bed) and is safely positioned on straddleable seat 212, he or she places his/her hands on handgrip 208. The user (or another individual) then applies a rotating force to move rotatable platform 204, straddleable seat 212, or the user, not specifically identified, in a desired direction and amount of rotation.

As rotatable platform 204 rotates to a desired stopping position, the user applies a braking force to handgrip 208 so as to stop further rotation of rotatable platform 204.

When at a desired exit position, the user may exit transitioning device 200.

Transitioning device 200 may be moved by lifting handle 216 so that transitioning device 200 may be rolled on wheels 214 to move device 200 to another location.

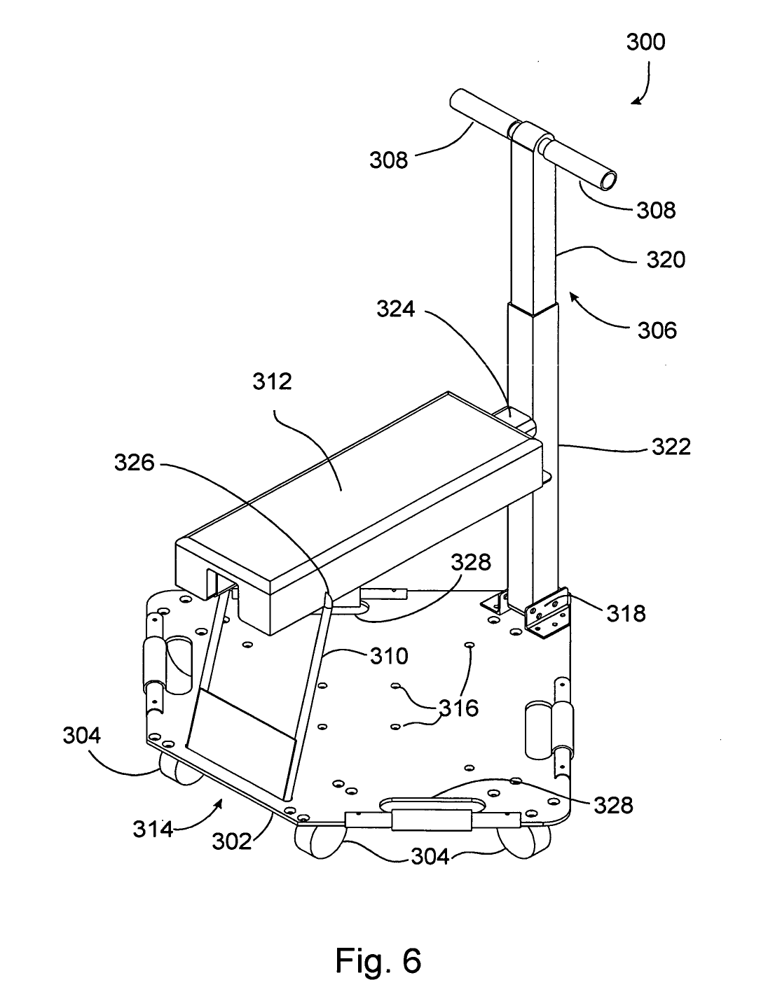

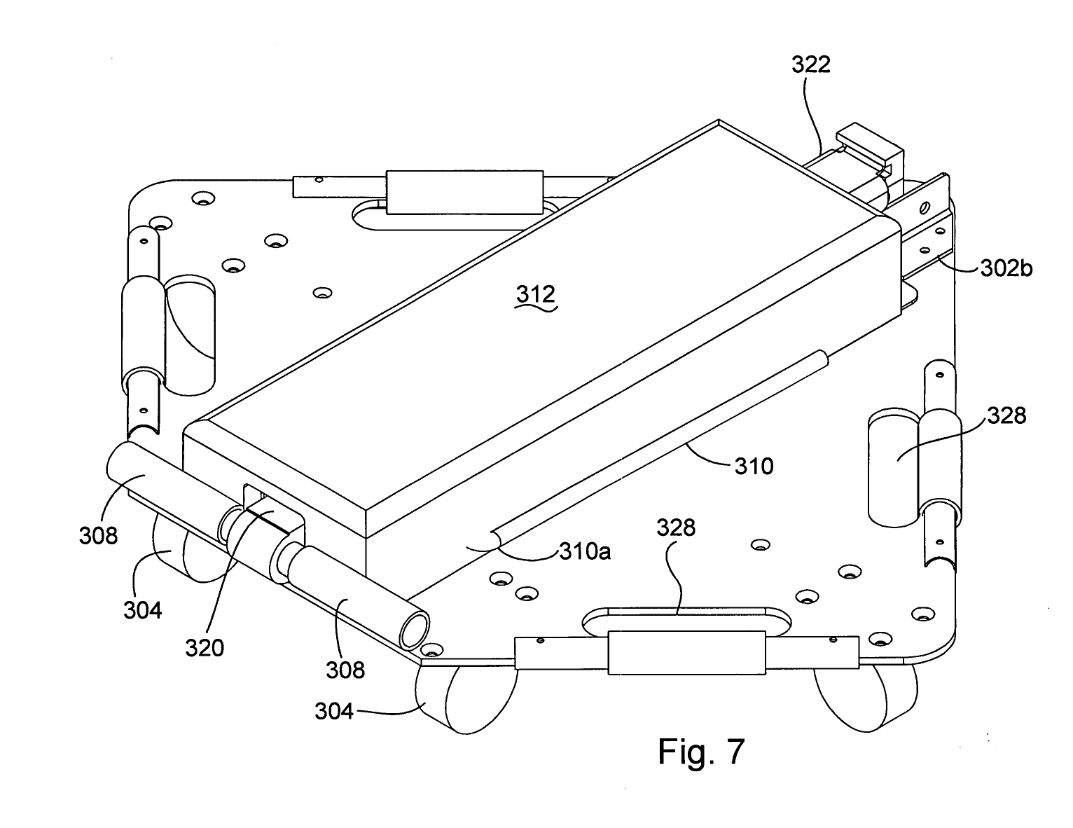

Referring now also to FIGS. 6 and 7, there are shown perspective, schematic views of a third embodiment of a collapsible transitioning device in an in a non-collapsed, operational configuration, and a collapsed, stowable configuration, respectively, generally at reference number 300.

Portable transitioning device 300 is intended for use primarily by emergency workers, for example emergency medical squad or ambulance workers, emergency room staff, or other persons who need assist persons such as to move, and if necessary, lift a person with limited mobility, physical handicaps or other infirmities from a first location (e.g., a bed) to a second location (e.g., stretcher, a wheel chair, an ambulance, etc.) safely and more easily.

Transitioning device 300 has a thin, planar, substantially rectangular support base plate 302. It may be desirable to cut away one corner 314 of support base plate 302 to form a pentagonal support base. It will be recognized that other shapes such as regular and irregular polygons for support base plate 302 may be chosen to meet a particular operating circumstance or environment. Consequently, the invention is not considered limited to the substantially rectangular or pentagonal shapes chosen for purposes of disclosure.

Support base plate 302 has a plurality of spaced apart through holes or receptacles 316 adapted to selectively receive and secure components of transitioning device 300.

A bracket 318 is secured to support base plate 302 proximate a corner opposite cut away corner 314 proximate a corner.

A vertical support column 306 consisting of an upper vertical support column member 320 and a lower vertical support column member 322 has a lower end attached to bracket 318 by one or more removable through pins or other similar securing device or mechanism, none shown.

Upper vertical support column 320 is slidably received in lower vertical support column member 322. A securing device, not shown, similar to the securing vertical support column 306 to bracket 318, not shown, is used to hold upper vertical support column member 320 in a desired height relationship with in lower vertical support column member 322. Such securements are believed to be well known to those of skill in the art and, consequently are not further described or discussed herein. In the embodiment chosen for purposes of disclosure, both upper vertical support column member 320 and a lower vertical support column member 322 are formed from square or rectangular metal tubing.

A pair of handgrips 308 is fixedly attached to an upper end of upper vertical support column member 320, generally orthogonally to a major axis of vertical support column 306.

Rotatable wheels or castors 304 are disposed on a bottom surface, not specifically identified, of support base plate 302, typically adjacent each of the corners thereof.

A straddleable seat 312 is positioned, retained and supported by contact with vertical support column 306 through retention means 324 that interacts with both a front portion of straddleable seat 312 and vertical support column 306. A rear portion of straddleable seat 312 is supported by a support bracket 310 pivotally attached thereto at a pivot point 326. A bottom portion of support bracket 310 is supported is connected to and supported upon support base plate 302 through one or more receptacles 316. The support for straddleable seat 312 is adequate for supporting a user thereupon so that the individual may safely be moved while on transitioning device 300.

Straddleable seat 312 may be made height adjustable. This may be accomplished by multiple, selectable connection points for retention means 324 on vertical support column 306. Further, additional receptacles 316, not shown, may be provided on support base plate 302 to allow support bracket 310 to moved so as to raise straddleable seat 312.

Access onto straddleable seat 312 is preferably from the back of the seat (i.e., the end furthest from vertical support column 306).

Elongated, rounded slots 328 that serve as handles are disposed in support base plate 302 proximate two or more sides thereof.

Unlike transitioning devices 100, 200 where a rotatable platform 106, 206, respectively, allow a straddleable seat 112, 212, respectively to be rotated with respect for bases 102, 202, respectively, transitioning device 300 has no separate rotatable platform. Instead, the entire planar base may be rotated on wheels or casters 304 to perform the same transitioning function. In other words, planar support base plate 302 is in and of itself the “rotatable platform, wheels or castors 304 allow straddleable seat 312 to be rotated.

As previously stated, transitioning device 300 is intended for portable use in or near an emergency facility such as an ambulance, an emergency room, first aid station, etc. for transporting an injured patient or a patient having limited mobility. Transitioning rotation is accomplished by rotating the entire support base plate 302 on wheels or casters 304 with a user seated on straddleable seat 312 and securing him or herself to vertical support column 306 and/or handgrips 308. Transitioning device 300 may be used to move an individual by a person gripping and pulling handgrips 308, or also by lifting and carrying transitioning device 300 and user to the desired location using slots 328.

Referring now also to FIG. 7, there is shown a perspective, schematic view of the transitioning device 300 of FIG. 6 in a collapsed, stowable or transportable configuration.

Transitioning device 300 may be “collapsed” by removing securing mechanisms retaining vertical support column 306 to bracket 318 and to secure upper vertical support column member 320 in a desired height relationship with in lower vertical support column member 322. Once removed, upper vertical support column member 320 is withdrawn fully into lower vertical support column member 322.

Retention means 324 on vertical support column 306 supporting a front portion of straddleabie seat 312 is released and seat support bracket 310 is removed from receptacle 316. Further, additional receptacles 316, not shown, may be provided on support base plate 302 to allow support bracket 310 to be folded against a bottom surface of straddleabie seat 312.

Vertical support column 306 may then be positioned horizontally on an upper surface of support base plate 302 and parallel thereto. Straddleable seat 312 is stored over the top thereof. In this collapsed configuration, transitioning device 300 may readily be transported or stowed.

Transitioning device 300 offers a great alternative especially when a device such as a wheel chair or a stretcher is not a practical solution to move a person (e.g., in confined spaces).

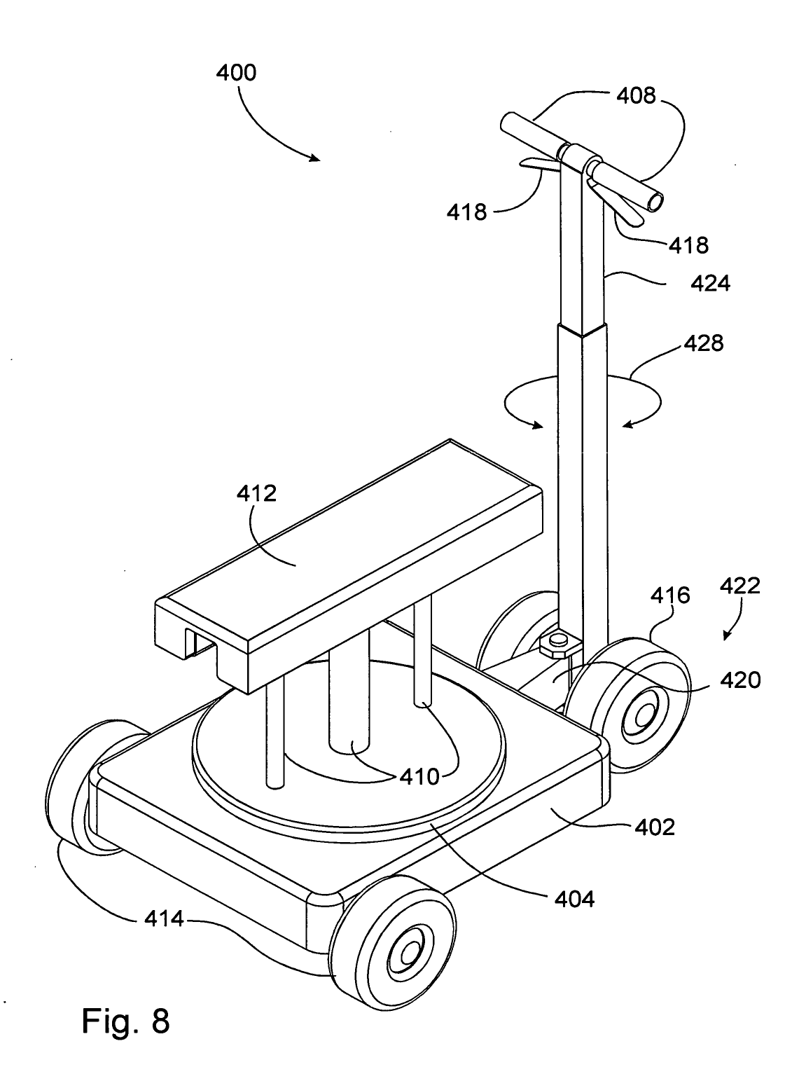

Referring now also to FIG. 8, there is shown a perspective, schematic view of another embodiment of a transporting and transitioning device in accordance with the invention, generally at reference number 400. Transporting and transitioning device 400 combines the functionality generally associated with an electrically powered chair or “scooter” with the transitioning devices 100 and 200. The functionality and necessary mechanisms for the mobility functionality of transporting and transitioning device 400 are believed to be well known to those of skill in the art. Consequently, these components, mechanisms, and systems are not further discussed herein. Any known arrangement of components may be utilized to “motorize” transitional devices 100, 200.

Transporting and transitioning device 400 has a hollow, substantially rectangular base 402.

Base 402 has a rotatable platform 404, typically supported on one or more ball or roller bearing devices, not shown on an upper surface of base 402. A drive mechanism, an example of which may be seen in FIG. 2, is operatively connected to rotatable platform 404. It will be recognized by those of skill in the art that numerous variants of the drive system of FIG. 2 may be implemented. Consequently, the invention is not considered limited to the drive system disclosed for purposes of disclosure. Rather any drive mechanism that may be configured to safely rotate rotatable platform 404 may be utilized and the invention encompasses all possible drive system variants.

An elongated, straddleable seat 412 is fixedly supported on rotatable platform 404 by seat supports 410.

A pair of driven wheels 414 is operatively connected to base 402 and to a drive motor, not shown, and any necessary intervening ancillary drive components including, but not limited to, belts, pulleys, sprockets, chains, gearboxes, transmissions, torque couplers, etc. As the specific components and arrangements for the drive system form no part of the present invention, they are not further disclosed or discussed herein. Such drive systems, drive system components and drive system arrangements are believed to be well known to those of skill in the art. A tongue 420 rigidly attached to base 402 projects forward from a front surface thereof. Tongue 420 is hingedly coupled to a front steering assembly 422. Front steering assembly 422 supports a pair of non-driven wheels 416.

Front steering assembly 422 supports a vertical support column 406 consisting of an upper vertical support column member 424 and a lower vertical support column member 426. Upper vertical support column 424 is slidably received in lower vertical support column member 426. A securing device, not shown, consisting of a through pin or similar securing mechanism is used to hold upper vertical support column member 424 in a desired height relationship with in lower vertical support column member 426. Such securements are believed to be well known to those of skill in the art and, consequently are not further described or discussed herein. Vertical support column 406 may be rotated, that is “steered”, by using handles 408 to move vertical support column 406 as shown by arrow 428.

In the embodiment chosen for purposes of disclosure, both upper vertical support column member 424 and a lower vertical support column member 426 are formed from square or rectangular metal tubing.

Vertical support column 406 has a T-structure, not specifically identified, having a pair of handgrips 408 disposed at either end thereof. A pair of lever activation switches 418 is provided, one of the pair of activation switches 418 being associated with a respective one of handgrips 408.

Activation switches 418 are used to generate the control signals necessary to control the various functions of device transporting and transitioning device 400. Such functions include but are not limited to “driving” (i.e., propelling) device 400, rotating rotatable platform 404 and, if otherwise implemented, adjusting the height of straddleable seat 412 relative to support base 402, and/or adjusting the position of straddleable seat 412 relative to rotatable platform 404.

Transporting and transitioning device 400 provides both transportation and rotary transitioning functions to a person with limited mobility, physical handicaps or similar limitations but having some arm strength. As discussed hereinabove, the novel transitioning devices of the invention are useful helping such persons to transition generally rotationally from a first location (e.g., a bed) not only to a second location (e.g., a wheel chair, a toilet seat, etc.) safely and more easily, but almost anywhere since device 400 is based on a powered wheelchair, thus allowing individuals even more opportunity to be more self-reliant.

In operation, a user mounts straddleable seat 412, typically from the rear of transporting and transitioning device 400. If transporting and transitioning device 400 is not oriented so that the user may readily mount straddleable seat 412, an appropriate lever activation switch 418 to turn rotatable platform 404 so that straddleable seat 412 is aligned for easy access to the person wishing to mount straddleable seat 412.

Once on straddleable seat 412, the user grasps handgrips 408 and activates an appropriate one(s) of lever activation switches 418 while applying a clockwise or counterclockwise twisting motion to the vertical support column 406 to align wheels 416 in a desired direction of travel. Travel may continue with the user steering wheels 416 along a desired path while manipulation level controls until a desired destination is reached.

When the user reaches his or her destination, lever activation switches 418 are used to rotate rotatable platform 404 to a suitable position for dismounting.

Device 400 may optionally include an adjustable suspension to further improve accessibility and comfort for a user.

As the embodiments disclosed hereinabove show, the invention may be implemented in many different ways: a) the base may be primarily non-movable, movable but non-powered, powered to rotate the base, and powered to move the entire overall device (i.e., a “powered wheelchair” or scooter); the source of power to provide motion may come from the user, the caregiver(s), or a powered motor; and there are many optional features that may be added to further enhance the safety and accessibility depending on the application.

The straddleable seats as disclosed in the various embodiments hereinabove may comprise options to further enhance the disclosed devices in various ways (i.e., safety, performance, ease-of-use, etc.). The straddleable seats may optionally also be adjustable in at least one direction (horizontally, vertically, etc.), either manually or through the use of a device such as a motor(s) to aid the user and/or the caregiver. The straddleable seats may also include features such as but not limited to a retractable seatback, sensors, vertical and/or horizontal arm supports or other features to aid the user, being foldable, being padded, being shaped, being sculpted, and being removable or detachable. Another possible variation to the straddleable seat is to have a portion of seat being fixed (preferably a more exterior portion), while the remainder (preferable the more interior portion) is attached to a rotatable platform disc, etc. The straddleable seats may even be round in shape, which may allow some users even more safe freedom of movement.

It should also be understood that the disclosed invention may be incorporated into new devices as well as potentially retrofit into existing devices. The disclosed devices may also include communications capability for use by the user or caregiver, and/or in communication the sensors or mechanisms of the device(s).

It should be understood by those skilled in the art that a device may, and typically does have many more components, some optional, some necessary, than those components identified and described in the embodiments disclosed hereinabove. For clarity, some components, which may be optionally included, may be intentionally excluded from the figures, along with additional mechanical parts, such as screws and nuts, wires, etc., many of which are not always easily externally visible. This is done only to enlighten and not obfuscate the invention. The specific component choices, based on material, weight, cost, etc., and locations of these various visible and hidden components probably would affect the design of a particular device, but this would only affect the details of the design, and not whether the inclusion of a straddlable seat would be beneficial. It should also be understood that the components that comprise the devices disclosed hereinabove are made of materials and dimensions that safely support individuals and meet all required local, state, and/or federal safety codes and regulations.

Since other modifications and changes varied to fit particular operating requirements and environments will be apparent to those skilled in the art, this invention is not considered limited to the representative examples chosen for purposes of this disclosure, and covers all changes and modifications which do not constitute departures from the true spirit and scope of this invention.

Having thus described the invention, what is desired to be protected by Letters Patent is presented in the subsequently appended claims.

What is claimed is:

1. A transitioning device for assisting a person with impaired mobility in transitioning from one position to another comprising:
a) a horizontal support base platform;
b) a seat assembly comprising an elongated, straddleable seat sized and configured to receive and support the buttocks of a user of said transitioning device disposed on said horizontal support base;
c) an optional rotatable platform comprising a flat upper surface interposed between said support base platform and said seat assembly;
d) a vertical support column attached to one selected from the group: said horizontal support base, and said optional rotatable platform, said vertical support column extending vertically upward therefrom; and
e) means for supporting said seat attached to said seat and to at least one chosen from the group: said rotatable platform and said vertical support column.

2. The transitioning device as recited in claim 1, wherein horizontal support base platform comprises an upper surface having a shape chosen from the group:
substantially rectangular, pentagonal, other regular or irregular polygon.

3. The transitioning device as recited in claim 2 further comprising:
f) a stationary safety handrail attached to at least one chosen from the group: said optional rotatable platform and said vertical support column, said safety handrail being attached thereto in a manner chosen from the group: fixedly, and removably.

4. The transitioning device as recited in claim 2, further comprising:
f) a drive system operatively connected to said optional rotatable platform, said drive system comprising a motor and at least one additional drive system component chosen from the group: a belts, pulleys, sprockets, chains, gearboxes, transmissions, and torque couplers.

5. The transitioning device as recited in claim 4, wherein said drive system further comprises:
g) means for powering said drive system operatively connected thereto, said means for powering comprising at least one chosen from the group: a battery, and means for connecting to an external electrical power source.

6. The transitioning device as recited in claim 5, further comprising:
h) an activation switch operatively connected to both said motor and said means for powering.

7. The transitioning device as recited in claim 6, wherein said activation switch is disposed proximate a safety handrail attached to at least one chosen from the group: said optional rotatable platform and said vertical support column.

8. The transitioning device as recited in claim 1, wherein said seat is selectively removable from said transitioning device.

9. The transitioning device as recited in claim 1, wherein said straddleable seat comprises a major upper surface substantially parallel to a surface selected from the group: an upper surface of said horizontal support base platform, and said upper surface of said optional rotatable platform.

10. The transitioning device as recited in claim 9, wherein said straddleable seat comprises a seat pad placed upon at least a portion of said major upper surface.

11. The transitioning device as recited in claim 9, further comprising:
f) at least one rotating device selected from the group: wheels and casters attached to said support base proximate a lower portion of a side thereof and at least two adjacent corners thereof.

12. The transitioning device as recited in claim 11, wherein at least one of said at least one rotating devices comprises a driven rotating device operatively connected to a source of motive power.

13. The transitioning device as recited in claim 11, further comprising:
g) a front steering assembly rotatively connected to a front edge of said support base. And wherein at least one of said at least one rotating devices is operatively attached to said front steering device.

14. The transitioning device as recited in claim 1, wherein said vertical support column is attached to said rotatable platform in at least one of the manners selected from the group: fixedly, removably, swivelably, and hingedly.

15. The transitioning device as recited in claim 2, wherein said transitioning is selectively convertible from an assembled, operational configuration and a disassembled, stowable configuration.

16. The transitioning device as recited in claim 2, wherein said vertical support column is fixedly attached to said support base and said support base is rotatable by a human.

17. The transitioning device as recited in claim 16, wherein said human supplying power to rotate said support base is selected from the group: a user of said transitioning device, and at least one human external to said transitioning device.
